(19) United States
(12) Patent Application Publication
(10) Pub. No.: US 2023/0274238 A1
(43) Pub. Date: Aug. 31, 2023

(54) METHODS FOR DETERMINING GARBAGE TREATMENT IN SMART CITIES, INTERNET OF THINGS SYSTEM, AND STORAGE MEDIUM

(71) Applicant: CHENGDU QINCHUAN IOT TECHNOLOGY CO., LTD., Chengdu (CN)

(72) Inventors: Zehua SHAO, Chengdu (CN); Haitang XIANG, Chengdu (CN); Yaqiang QUAN, Chengdu (CN); Yong LI, Chengdu (CN); Xiaojun WEI, Chengdu (CN)

(73) Assignee: CHENGDU QINCHUAN IOT TECHNOLOGY CO., LTD., Chengdu (CN)

(21) Appl. No.: 17/932,305

(22) Filed: Sep. 15, 2022

(30) Foreign Application Priority Data
Aug. 30, 2022 (CN) 202211043834.1

(51) Int. Cl. G06Q 10/00; G06V 20/52

(52) U.S. Cl. CPC G06Q 10/30; G06V 20/52; G06V 2201/07

(57) ABSTRACT

The disclosure provides a method for determining garbage treatment in a smart city, an Internet of Things system, and storage medium. The Internet of Things system includes a management platform, a sensor network platform, and an object platform. The method includes: obtaining an image of at least one garbage gathering point in a preset area and a scale of the preset area based on the object platform; determining a current garbage amount of at least one garbage gathering point based on the image; determining a garbage growth rate of at least one garbage gathering point based on the scale of the preset area; determining a target garbage gathering point based on the current garbage amount of at least one garbage gathering point and the garbage growth rate of at least one garbage gathering point; and controlling a garbage treatment device to treat garbage at the target garbage gathering point.

### CROSS-REFERENCE TO RELATED DISCLOSURES

This application claims priority to Chinese Patent Application No. 202211043834.1, filed on Aug. 30, 2022, the entire contents of which are hereby incorporated by reference.

### TECHNICAL FIELD

The disclosure relates to the field of Internet of Things and cloud platforms, in particular to methods for determining garbage treatment in smart cities, and Internet of Things systems, and storage medium.

### BACKGROUND

With the development of urban construction and the improvement of living standards, the amount of urban domestic waste has increased day by day, and the cost of labor and material resources for garbage treatment has also increased accordingly. At present, the order of garbage treatment mainly depends on manual experience, which is time-consuming and labor-consuming and inevitably causes mistakes, resulting in lagging garbage treatment in some places and polluting the environment and affecting the city appearance.

Therefore, a method for determining garbage treatment in a smart city, an Internet of Things system, and a storage medium are desirable to be provided, which may determine a more scientific, reasonable and effective garbage treatment order in a timely manner and improve the efficiency of garbage treatment, so as to improve the city appearance and facilitate creating a cleaner and more orderly and civilized urban environment.

### SUMMARY

One or more embodiments of the disclosure provide a method for determining garbage treatment in a smart city, which is implemented based on an Internet of Things system for determining garbage treatment in a smart city. The Internet of Things system for determining the garbage treatment in the smart city includes a management platform, a sensor network platform, and an object platform. The method is executed by the management platform, including: obtaining an image of at least one garbage gathering point in a preset area and a scale of the preset area based on the object platform; determining a current garbage amount of the at least one garbage gathering point based on the image of the at least one garbage gathering point; determining a garbage growth rate of the at least one garbage gathering point based on the scale of the preset area; determining a target garbage gathering point based on the current garbage amount of the at least one garbage gathering point and the garbage growth rate of the at least one garbage gathering point; and controlling a garbage treatment device to treat garbage at the target garbage gathering point.

One or more embodiments of the disclosure provide an Internet of Things system for determining the garbage treatment in the smart city, including a management platform, a sensor network platform, and an object platform. The object platform is configured to obtain the image of the at least one garbage gathering point in the preset area and the scale of the preset area and transmit the image of the at least one garbage gathering point to the management platform through the sensor network platform based on the object platform; the management platform is configured to determine the current garbage amount of the at least one garbage gathering point based on the image of the at least one garbage gathering point; determine the garbage growth rate of the at least one garbage gathering point based on the scale of the preset area; and determine the target garbage gathering point based on the current garbage amount of the at least one garbage gathering point and the garbage growth rate of the at least one garbage gathering point.

One or more embodiments of the disclosure provide a non-transitory computer readable storage medium, the storage medium stores computer instructions, and when the computer instructions are executed by a processor, the method for determining the garbage treatment in the smart city is implemented.

The disclosure aims to overcome the problem of lagging treatment and environmental pollution of certain garbage gathering points. By obtaining the image of the garbage gathering point in the preset area and the scale of the preset area, the current garbage amount and garbage growth rate of the garbage gathering point are determined so as to determine the target garbage gathering point. The target garbage gathering point may be more accurately obtained, and the garbage treatment device is controlled to treat garbage in the area, improving the accuracy and timeliness of garbage treatment work, and avoiding problems such as lagging treatment of garbage at certain locations, and easy pollution to the environment and affecting the city appearance, etc.

### BRIEF DESCRIPTION OF THE DRAWINGS

This description will be further illustrated by means of exemplary embodiments, which will be described in detail through accompanying drawings. These embodiments are not restrictive, in which the same numbering indicates the same structure, wherein:

FIG. 1 is a schematic diagram of an application scenario of the Internet of Things system for determining the garbage treatment in the smart city according to some embodiments of this disclosure.

FIG. 2 is a schematic diagram of a structure of the Internet of Things system for determining the garbage treatment in the smart city according to some embodiments of this disclosure.

FIG. 3 is an exemplary flow chart of the method for determining the garbage treatment in the smart city according to some embodiments of this disclosure.

FIG. 4 is an exemplary flow chart of a method for determining the garbage growth rate of the at least one garbage gathering point according to some embodiments of this disclosure.

FIG. 5 is a schematic diagram of an exemplary process for determining the population activity of the preset area at the future time according to some embodiments of this disclosure.

FIG. 6 is a schematic diagram of an exemplary process for determining a level of household garbage generation according to some embodiments of this disclosure.

### DETAILED DESCRIPTION

In order to more clearly explain the technical scheme of the embodiment of this disclosure, a brief description of the accompanying drawings required for the embodiment description is given below. Obviously, the accompanying drawings below are only some examples or embodiments of this disclosure, and it is possible for ordinary technicians skilled in the art to apply this description to other similar scenarios according to these accompanying drawings without creative effort. Unless obviously obtained from the context or the context illustrates otherwise, the same numeral in the drawings refers to the same structure or operation.

It should be understood that the words “system”, “device”, “unit” and/or “module” used in this disclosure are a method used to distinguish different components, elements, parts, portions or assemblies of different levels. However, if other words serve the same purpose, the words may be replaced by other expressions.

As shown in this description and claims, the words “one”, “a”, “a kind” and/or “the” are not special singular but may include the plural unless the context expressly suggests otherwise. In general, the terms “comprise” and “include” imply the inclusion only of clearly identified steps and elements that do not constitute an exclusive listing. A method or equipment may also include other steps or elements.

Flow charts are used in this disclosure to illustrate the operation performed according to the system of the embodiments of this disclosure. It should be understood that the previous or subsequent operations may not be accurately implemented in order. Instead, each step may be processed in reverse order or simultaneously. Meanwhile, other operations may also be added to these processes, or a certain step or several steps may be removed from these processes.

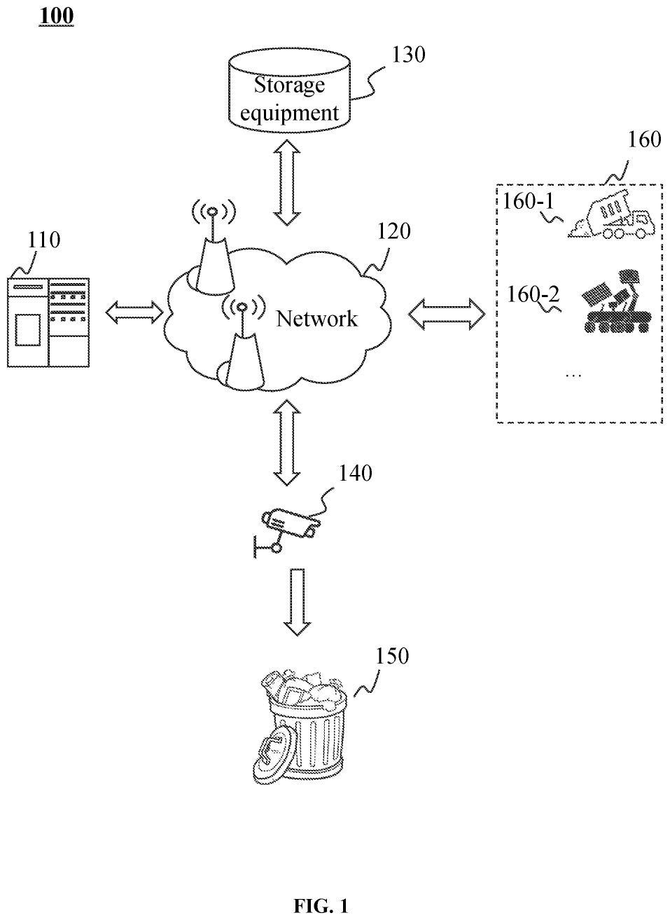

FIG. 1 is a schematic diagram of an application scenario 100 of the Internet of Things system for determining the garbage treatment in the smart city in some embodiments of this disclosure. In some embodiments, the application scenario 100 may include a processing equipment 110, a network 120, a storage equipment 130, a monitoring device 140, a garbage gathering point 150, and a garbage treatment device 160.

In some embodiments, the application scenario 100 of the Internet of Things system for determining the garbage treatment in the smart city may determine the garbage treatment by implementing the method and/or the processes disclosed in this disclosure.

The processing equipment 110 may be used to process data related to the Internet of Things system for determining the garbage treatment in the smart city. For example, the processing equipment 110 may determine the current garbage amount and the garbage growth rate of the at least one garbage gathering point by implementing the method for determining the garbage treatment in the smart city disclosed in this disclosure. In some embodiments, the processing equipment 110 may be a single server or a server group. The server group may be centralized or distributed.

The network 120 may connect to all the components and/or external resource parts of the application scenario 100 of the Internet of Things system for determining the garbage treatment in the smart city. In some embodiments, one or more components (e.g., the processing equipment 110, the storage equipment 130, the monitoring device 140, the garbage gathering point 150, and the garbage treatment device 160) of the application scenario of the Internet of Things system for determining the garbage treatment in the smart city may exchange information and/or data through the network 120. For example, the network 120 may send monitoring information of the garbage gathering point 150 obtained by the monitoring device 140 to the processing equipment 110. As another example, the processing equipment 110 may control the garbage treatment device 160 to treat the garbage of the garbage gathering point through the network 120. In some embodiments, the network 120 may be any or more of a wired network or a wireless network.

The storage equipment 130 may store data, instructions and/or any other information. For example, the scale of the preset area may be stored in the storage equipment 130. In some embodiments, the storage equipment 130 may store data obtained from the monitoring device 140 and/or the processing equipment 110. For example, the storage equipment 130 may obtain an entry and exit record of entrances and exits in the preset area to be stored from the processing equipment 110. The storage equipment 130 may include one or more storage components. Each storage component may be an independent equipment or part of other equipment.

The monitoring device 140 refers to a device that monitors the preset area. For example, the monitoring device 140 may include a panoramic camera, a monitoring camera, a drone, etc. The monitoring device 140 may obtain monitoring information related to the preset area, and the monitoring information may include images, videos, voice, or the like, or any combination thereof. In some embodiments, the monitoring device 140 may send the collected data information related to monitoring to other components (e.g., the processing equipment 110) of the application scenario 100 of the Internet of Things system for determining the garbage treatment in the smart city or other components beyond the application scenario 100 of the Internet of Things system for determining the garbage treatment in the smart city through the network 120.

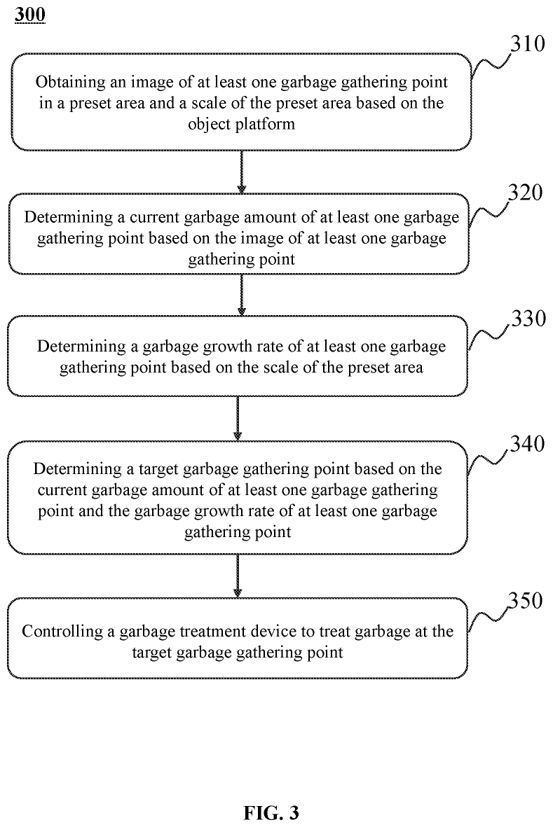

The garbage gathering point 150 refers to the place where the garbage is placed in a centralized manner. For example, the garbage gathering point in community A may be at the gate of building 1. In some embodiments, the garbage gathering point 150 may include garbage collection facilities such as a garbage can, a garbage pavilion, a garbage room, etc. In some embodiments, the processing equipment 110 may obtain the monitoring image of the garbage gathering point 150 by the monitoring device 140 through the network 120. For more details of the garbage gathering point 150, please see FIG. 3 and its related descriptions.

The garbage treatment device 160 refers to a device or equipment capable of treating the garbage, such as a garbage clearance vehicle 160-1, a garbage transfer robot 160-2, etc. In some embodiments, the processing equipment 110 may control the garbage treatment device 160 through the network 120 to the target garbage gathering point to treat the garbage. For more details of the garbage treatment device 160, please see FIG. 3 and its related descriptions.

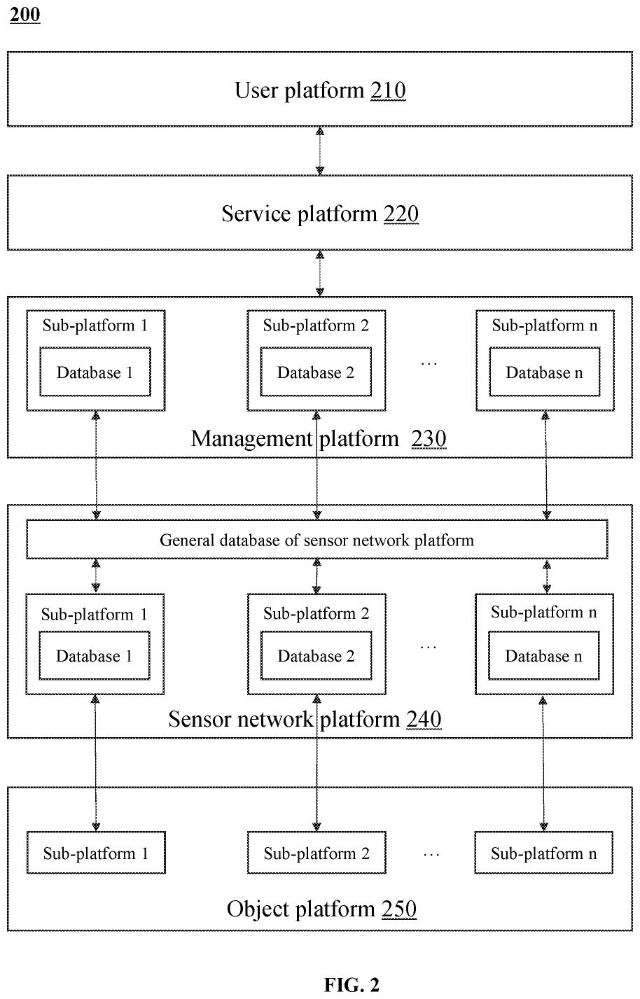

FIG. 2 is a schematic diagram of the framework of the Internet of Things system 200 for determining the garbage treatment in the smart city according to some embodiments of this disclosure.

As shown in FIG. 2, the Internet of Things system 200 for determining the garbage treatment in the smart city includes: a user platform 210, a service platform 220, a management platform 230, a sensor network platform 240, and an object platform 250, which interact in turn.

The user platform 210 may refer to a platform dominated by users, including a platform for obtaining the needs of a user and feeding back information to the user. In some embodiments, the user platform is configured as terminal equipment that feeds the target garbage gathering point back to the user.

In some embodiments, the user platform 210 may interact down with the service platform 220, such as issuing an instruction for controlling the garbage treatment device to treat the garbage of the target garbage gathering point to the service platform 220, and receiving the target garbage gathering point uploaded by the service platform 220, etc.

The service platform 220 may refer to a platform that preliminarily process the user's query request. In some embodiments, receiving, processing, and sending data or/and information are carried out by the platform.

In some embodiments, the service platform 220 may interact down with the management platform 230, such as issuing a target garbage gathering point query instruction to the management platform 230, and receiving the target garbage gathering point uploaded by the management platform 230.

In some embodiments, the service platform 220 may also interact up with the user platform 210, such as receiving the target garbage gathering point query instruction issued by the user platform 210, and uploading the target garbage gathering point to the user platform 210, etc.

In some embodiments, the management platform 230 includes a plurality of management sub-platforms. The plurality of management sub-platforms correspond to a plurality of management sub-platform databases in a one-to-one manner, and the plurality of management sub-platforms correspond to different city areas.

In some embodiments, the management platform 230 is a platform for performing the method for determining the garbage treatment in the smart city. In some embodiments, the management platform 230 may process the data related to garbage monitoring uploaded by the sensor network platform 240 to determine the target garbage gathering point in response to the user's query request.

In some embodiments, the management platform 230 is configured as a second server. The management platform includes a plurality of independent sub-platforms, which operate and process data independently, and directly interact with upper and lower functional platforms. A plurality of sub-platforms are divided according to the city areas and correspond to sensor network sub-platforms in a one-to-one manner.

In some embodiments, the management platform 230 may interact down with the sensor network platform 240, such as receiving and processing the data related to garbage monitoring of each area uploaded by the sensing network platform 240, and issuing an instruction for obtaining the data related to garbage monitoring to the sensor network platform 240, etc.

In some embodiments, the management platform 230 may interact up with the service platform 220, such as receiving the target garbage gathering point query instruction issued by the service platform 220, uploading the target garbage gathering point to the service platform 220, etc.

In some embodiments, processing the data related to garbage monitoring of different preset areas through the management sub-platforms may reduce the data processing pressure of the entire management platform, and make each area of the city independently manage the target garbage gathering point of each area so as to be more targeted.

The sensor network platform 240 may refer to a platform for transmitting the data related to garbage monitoring to the management platform 230. In some embodiments, the sensor network platform 240 is configured as a communication network and a gateway, which is provided with a general database and a plurality of sub-platforms (including sub-platform databases). A plurality of sub-platforms respectively store and process different types of data or data of different receiving objects sent by the object platform 250. The general database stores and processes the data of a plurality of sub-platforms and transmits the data of a plurality of sub-platforms to the management platform 230 after summarizing.

In some embodiments, the sensor network platform 240 includes a plurality of sensor network sub-platforms. A plurality of sensor network sub-platforms are divided according to the city areas and correspond to a plurality of sub-platforms of the management platform in a one-to-one manner. In some embodiments, a plurality of sensor network sub-platforms are configured as independent gateways, which may be used to obtain the data related to garbage monitoring uploaded by the object platform 250.

In some embodiments, the sensor network platform 240 may interact down with the object platform 250, such as receiving the data related to garbage monitoring uploaded by the object platform 250, issuing the instruction for obtaining the data related to garbage monitoring to the object platform 250, etc.

In some embodiments, the sensor network platform 240 may interact up with the management platform 230, such as receiving the instructions for obtaining the data related to garbage monitoring issued by the management sub-platforms, uploading the data related to garbage monitoring of the general database of the sensor network platform to the corresponding management sub-platforms, etc.

The object platform 250 may be a functional platform for generating perception information and finally executing control information. In some embodiments, the object platform 250 is configured as monitoring equipment. In some embodiments, the object platform 250 includes a plurality of object sub-platforms, which correspond to a plurality of sensor network sub-platforms in a one-to-one manner. In some embodiments, a plurality of object sub-platforms may collect the data related to garbage monitoring in different preset areas of the city.

In some embodiments, the object platform 250 may interact up with the sensor network platform 240, such as receiving the instruction for obtaining the data related to garbage monitoring issued by the sensor network sub-platforms, uploading the data related to garbage monitoring to the corresponding sensor network sub-platform databases, etc.

FIG. 3 is an exemplary flow chart of the method for determining the garbage treatment in the smart city according to some embodiments of this disclosure. As shown in FIG. 3, the process 300 includes the following steps. In some embodiments, one or more operations of the process 300 shown in FIG. 3 may be implemented in the application scenario 100 of the Internet of Things system for determining the garbage treatment in the smart city shown in FIG. 1. In some embodiments, the process 300 may be performed by the management platform 230.

Step 310, obtaining the image of the at least one garbage gathering point in the preset area and the scale of the preset area based on the object platform.

The preset area may refer to a preset range of terrain, such as a certain block, a certain community, etc. In some embodiments, the management platform 230 may determine a plurality of preset areas in a plurality of ways. In some embodiments, the preset areas may correspond to the administrative division areas of the city. For example, the preset areas of Chengdu may include Qingyang District, Jinjiang District, Wuhou District, etc. In some embodiments, the preset areas may correspond to the communities in the city. For example, the preset areas of Chengdu may include communities A, B, and C.

In some embodiments, the management platform 230 may obtain the image of the garbage gathering point taken by a monitoring device 140 located in the preset area based on the object platform 250.

The scale of the preset area refers to the parameters that reflect the size of the preset area. For example, the scale of community A may be a population of 35,000.

In some embodiments, the management platform 230 may obtain the scale of the preset area by big data analysis, such as by obtaining a large amount of data for statistical analysis or other processing through the data of telecom operators.

In some embodiments, the management platform 230 may obtain the scale of the preset area through third-party platform analysis. As another example, the management platform 230 may obtain the number of registered households and the registered population of each household in the community A through the Chengdu government service platform, thereby determining the population of the community A, and then determining the scale of the community A.

Step 320, determining the current garbage amount of the at least one garbage gathering point based on the image of the at least one garbage gathering point.

The current garbage amount refers to the total garbage amount placed at a certain garbage gathering point at the current time point. For example, the current garbage amount of the garbage gathering point at the east gate of the community A is 500 liters at 08:00 a.m. on Jan. 1, 2025.

In some embodiments, the management platform 230 may determine the current garbage amount of the at least one garbage gathering point based on the image of the at least one garbage gathering point. For example, the garbage gathering point at the east gate of the community A includes 10 garbage cans with a volume of 200 liters. At 12:00 noon on Jan. 1, 2025, the image of the garbage gathering point shows that 5 garbage cans are filled, 1 garbage can is half-filled, and 4 garbage cans are empty, and thus the current garbage amount of the garbage gathering point is 1100 liters.

Step 330, determining the garbage growth rate of the at least one garbage gathering point based on the scale of the preset area.

The garbage growth rate refers to the increased amount of garbage per unit time, the increased amount may be represented by volume. For example, the garbage growth rate of the garbage gathering point at the east gate of the community A may be 100 liters/hour.

In some embodiments, the management platform 230 may determine the garbage growth rate of the at least one garbage gathering point based on the scale of the preset area.

In some embodiments, the management platform 230 may collate historical data such as the historical scale and historical garbage growth rate of a plurality of preset areas into a data comparison table, and determine the garbage growth rate based on the data comparison table. For example, the historical scale of community A is a population of 1,000, and the historical garbage growth rate is 100 liters/hour based on the data comparison table, the garbage growth rate may be determined as 200 liters/hour when the scale of community B is a population of 2,000.

In some embodiments, the management platform 230 may determine a level of household garbage generation in the preset area based on the water and electrical data of residents in the preset area, and determine the garbage growth rate of the at least one garbage gathering point based on the scale of the preset area and the level of household garbage generation in the preset area.

The residents refer to person living in the preset area. The water and electrical data of the residents refers to data related to domestic water, electricity and gas consumption of the residents. For example, the water and electrical data of the residents may be the total amount of water and electricity consumed by the residents per year.

The level of household garbage generation refers to numerical values or letters reflecting the amount of garbage generated by the residents. For example, the level of household garbage generation may be represented by the numerical values 1-10, the letters a-f, or star ratings. The higher numerical value is, the higher letter rank is, or the higher star rating is, which indicates that the higher level of household garbage generation is and the more garbage produced by the residents is.

In some embodiments, the level of household garbage generation may be determined according to the water and electrical data of the residents in the preset area, and the water and electrical data may be the weighted average of the data related to water, electricity, and gas consumption of the residents. For example, presuming that the total annual water and electricity consumption of the residents in the range of 10,000˜13,000, 13,000˜16,000, 16,000˜19,000, 19,000˜22,000, and 22,000˜25,000 correspond to level 1, level 2, level 3, level 4, and level 5 of household garbage generation, if the annual water consumption of the residents in the community A is 7500 tons, the electricity consumption is 150,000 kW h, and the gas consumption is 30,000 cubic meters, the water and electrical data of the residents may be 7500×75%+150000×5%+30000×20%=19125, and the corresponding level of household garbage generation is level 4.

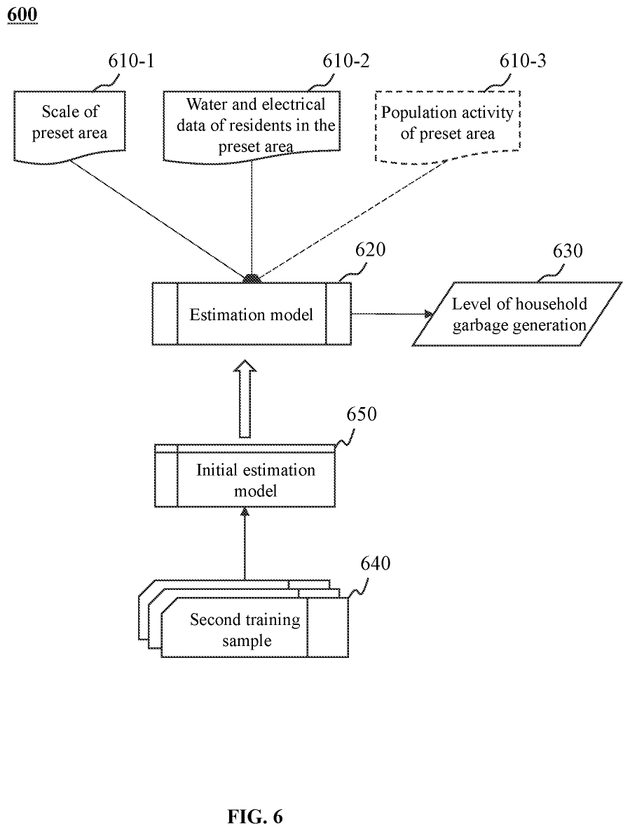

In some embodiments, the management platform 230 may determine the level of household garbage generation through a prediction model based on the scale of the preset area and the water and electrical data of the residents in the preset area. For more details of determining the level of household garbage generation through the prediction model, please see FIG. 6 and its related descriptions.

In some embodiments, the management platform 230 may determine the garbage growth rate of the at least one garbage gathering point based on the level of household garbage generation in the preset area. In some embodiments, the management platform 230 may collate historical data such as the historical levels of household garbage generation and the historical garbage growth rates into the data comparison table, and determine the garbage growth rate based on the data comparison table. For example, the historical level of household garbage generation based on the data comparison table is level 2, and the corresponding historical garbage growth rate is 100 liters/hour, it is determined that the garbage growth rate of the community A with the level 2 of household garbage generation is 100 liters/hour.

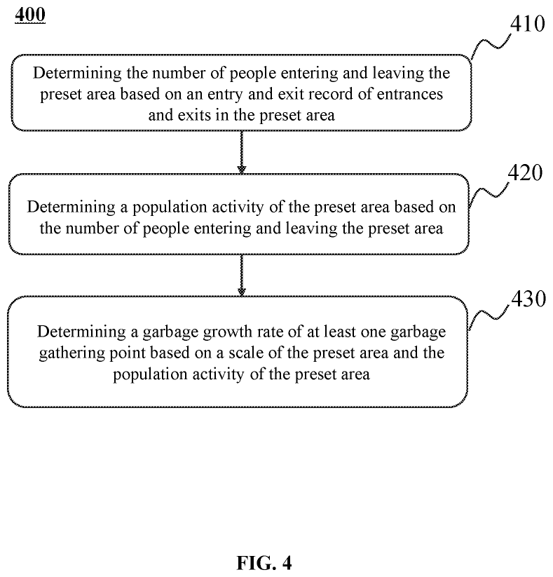

In some embodiments, the management platform 230 may determine the number of people entering and leaving the preset area based on an entry and exit record of entrances and exits in the preset area, and determine a population activity of the preset area based on the number of people entering and leaving the preset area. Therefore, the management platform 230 may determine the garbage growth rate of the at least one garbage gathering point based on the scale of the preset area and the population activity of the preset area. For more details about determining the garbage growth rate of the at least one garbage gathering point based on the scale of the preset area and the population activity of the preset area, please see FIG. 4 and its related descriptions.

Step 340, determining a target garbage gathering point based on the current garbage amount of the at least one garbage gathering point and the garbage growth rate of the at least one garbage gathering point.

The target garbage gathering point refers to a garbage gathering point to be treated. For example, if the garbage gathering point at the east gate of the community A is to be treated, the garbage gathering point may be the target garbage gathering point.

In some embodiments, the management platform 230 may determine the estimated fill-up time of the garbage can based on the current garbage amount and the corresponding garbage growth rate of each garbage gathering point, and determine the garbage gathering point with the earliest estimated fill-up time to be the target garbage gathering point. For example, the current garbage amounts of a garbage gathering point A and a garbage gathering point B are 1000 L and 800 L, the garbage growth rates are 100 L/h and 200 L/h respectively, the garbage amounts after fill-up are 1500 L and 2000 L, thus the estimated fill-up time of the garbage gathering point A and the garbage gathering point B is 5 h and 6 h respectively. Because the garbage gathering point A is expected to be filled up first, it may be determined that the garbage gathering point A is the target garbage gathering point.

Step 350, controlling the garbage treatment device to treat the garbage of the target garbage gathering point.

In some embodiments, the processing equipment 110 may issue a control instruction to the garbage treatment device to control the garbage treatment device to treat the garbage of the target garbage aggregation point. The control instruction refers to an instruction for controlling the garbage treatment device to implement specific operations, at least including time and place, and one or any combination of accompanying personnel, amount of garbage to be treated, planning paths, etc. For example, the control instruction for a garbage vehicle may be going to the garbage gathering point at the east gate of community A to treat 2,000 liters of garbage at 7:00 a.m., on Jan. 1, 2025, and the accompanying personnel being a sanitation worker B and a sanitation worker C.

According to some embodiments of this disclosure, the current garbage amount and the garbage growth rate of the garbage gathering point are determined by obtaining the image of the garbage gathering point in the preset area and the scale of the preset area to further determine the target garbage gathering point. The more accurate target garbage gathering point may be obtained, and the garbage treatment device may be controlled to treat the garbage in the area, improving the accuracy and timeliness of garbage treatment work, and avoiding problems such as lagging garbage treatment of certain locations, and causing pollution to the environment and affecting the city appearance.

FIG. 4 is an exemplary flow chart of a method for determining the garbage growth rate of the at least one garbage gathering point according to some embodiments of this disclosure. As shown in FIG. 4, the process 400 includes the following steps. In some embodiments, one or more operations of the process 400 shown in FIG. 4 may be implemented in the application scenario 100 of the Internet of Things system for determining the garbage treatment in the smart city shown in FIG. 1. In some embodiments, the process 400 may be performed by the management platform 230.

Step 410, determining the number of people entering and leaving the preset area based on an entry and exit record of entrances and exits in the preset area.

The entrances and exits may be channel ports for entering and leaving the preset area. For example, the entrances and exits of the community A may be gate 1, gate 2, east gate, north gate, etc. In some embodiments, security facilities may be placed at the entrances and exits, such as an access gate, a monitoring device, etc.

The entry and exit record refers to relevant record information of personnel entering and leaving the entrances and exits of the preset area. For example, the entry and exit record of the community A may be the monitoring information of the personnel entering and leaving the east gate. In some embodiments, the entry and exit record may include one or more combinations of images, videos, voice, etc.

The number of people entering and leaving refers to the sum of the number of people entering and leaving the entrances and exits of the preset area within a certain time period. For example, the number of people entering and leaving the east gate of the community A from 08:00 to 12:00 on Jan. 1, 2025 is 600.

In some embodiments, the management platform 230 may determine the number of people entering and leaving the preset area based on the entry and exit record of the entrances and exits of the preset area. For example, the management platform 230 may determine the number of people entering and leaving the preset area based on the entry and exit record of the access gate of the entrances and exits of the east gate of the community A.

Step 420, determining a population activity of the preset area based on the number of people entering and leaving the preset area.

The population activity refers to the activity degree of population in the preset area within a certain time period. In some embodiments, the population activity in the preset area within the certain time period is proportional to the number of people entering and leaving the preset area.

In some embodiments, the management platform 230 may determine the population activity of the preset area based on the number of people entering and leaving the preset area.

In some embodiments, the management platform 230 may directly use the number of people entering and leaving the preset area as the population activity of the preset area. For example, the number of people entering and leaving the east gate of the community A from 08:00 to 12:00 on Jan. 1, 2025 is 600, thus the population activity may be 600.

In some embodiments, the management platform 230 may determine a flow of people of the road around the preset area, and determine the population activity of the preset area based on the number of people entering and leaving the preset area and the flow of people of the road around the preset area.

The flow of people of the road around the preset area refers to the number of people passing the road around the preset area within a certain time period. For example, the flow of people of the road around the community A from 08:00 to 12:00 on Jan. 1, 2025 is 500.

In some embodiments, the management platform 230 may determine the flow of people of the road around the preset area through an image recognition model. The image recognition model may be a machine learning model. The image recognition model may recognize and process the collected road images of the road around the preset area within the certain time period to determine the flow of people of the road around the preset area.

In some embodiments, the road images of the road around the preset area within the certain time period may be obtained by one or more monitoring devices installed on the road around the preset area. The monitoring devices may be cameras or webcam installed on the road around the preset area.

In some embodiments, the image recognition model may be a Convolutional Neural Networks (CNN) model. In some embodiments, the input of the image recognition model may include a road picture sequence of the road around the preset area within the certain time period, and the output of the image recognition model may include the flow of people of the road around the preset area within the certain time period. The road picture sequence of the road around the preset area within the certain time period may include a sequence composed of pictures of the road around the preset area at a certain time interval (e.g., 1s, 5s, 30s, etc.) within the certain time period. The image recognition model may perform feature extraction on the road picture sequence of the road around the preset area within the certain time period, and determine the flow of people of the road around the preset area within the certain time period based on extracted feature values. The feature values may be outlines of the people detected in the images.

In some embodiments, the image recognition model may be trained through a plurality of tagged training samples. A plurality of tagged training samples may be inputted into an initial image recognition model. A loss function is constructed by the tags and the results of the initial image recognition model, and the parameters of the initial image recognition model are updated based on the loss function. Model training is completed when the loss function of the initial image recognition model meets the preset conditions, and the trained initial image recognition model is obtained. In some embodiments, the training samples may at least include road images of the road around the sample area in a certain time period, and the tags may be the flow of people of the road around the sample area. The tags may be obtained by manually labeling the images of the sample area.

In some embodiments, the management platform 230 may determine the population activity of the preset area based on the number of people entering and leaving the preset area and the flow of people of the road around the preset area.

In some embodiments, the number of people entering and leaving the preset area and the flow of people of the road around the preset area are proportional to the population activity of the preset area. That is, the more the number of people entering and leaving the preset area is and the higher the flow of people of the road around the preset area is, the higher the population activity of the preset area is.

In some embodiments, the management platform 230 may set a first preset rule for the number of people entering and leaving the preset area and the flow of people of the road around the preset area and the population activity of the preset area, and determine the population activity of the preset area based on the first preset rule. For example, the management platform 230 may set the first preset rule as that the population activity of the preset area is the sum of the number of people entering and leaving the preset area and the flow of people of the road around the preset area. Exemplarily, the number of people entering and leaving the community A from 08:00 to 12:00 on Jan. 1, 2025 is 600 and the flow of people of the road around the preset area is 500, thus the population activity is 1100.

The population activity of the preset area is jointly determined by the number of people entering and leaving the preset area and the flow of people of the road around the preset area. Considering the garbage generated by the people on the road around the preset area, the determined population activity of the preset area is more comprehensive and accurate.

In some embodiments, the flow of people of the road around the preset area may include a consumption flow of people of ground floor shops of the road around the preset area. The ground floor shops may refer to shops at the entrance of the preset area or near the preset area, for example, the ground floor shops of the community A may be shops within a range with the community A as the center and 300 meters as the radius.

In some embodiments, the management platform 230 may determine the consumption flow of people of the ground floor shops of the road around the preset area through the image recognition model. In some embodiments, the input of the image recognition model may include an entrance picture sequence of the ground floor shops of the road around the preset area within the certain time period, and the output of the image recognition model may include the consumption flow of people of the ground floor shops of the road around the preset area within the certain time period. For more contents such as training of the image recognition model, please refer to the relevant descriptions of determining the flow of people of the road around the preset area through the image recognition model, which will not be repeated here.

In some embodiments, the garbage generated by consumers from the ground floor shops of the road around the preset area is more than that generated by consumers from other places of the road around the preset area, thus the proportion of the consumption flow of people of the ground floor shops of the road around the preset area to the flow of people of the road around the preset area is proportional to the population activity of the preset area, and the population activity of the preset area is proportional to the garbage growth rate of at least one garbage gathering point.

For example, if the consumption flow of people of the ground floor shops of the road around the community A is 30, the flow of people of the road around the community A is 100, and the proportion of the consumption flow of people of the ground floor shops of the road around the community A to the flow of people of the surrounding road is 3:10, the population activity of the community A may be 30×2+(100−30)=130, and the corresponding garbage growth rate may be 60 L/h. If the consumption flow of people of the ground floor shops of the road around the community A is 10, the flow of people of the road around the community A is 100, and the proportion of the consumption flow of people of the ground floor shops of the road around the community A to the flow of people of the road around the community A is 1:10, the population activity of the community A may be 10×2+(100−10)=110, and the corresponding garbage growth rate may be 50 L/h.

When determining the population activity of the preset area, considering that the garbage generated by the consumers from the ground floor shops of the road around the preset area is more than that generated by the consumers of other places of the road around the preset area, the determined population activity of the preset area is more comprehensive and accurate.

The future time refers to a certain time point after the current time point. For example, when the current time point is 08:00 a.m. on Jan. 1, 2025, the future time may be 09:15 a.m. on Jan. 1, 2025.

In some embodiments, the greater population activity of the preset area at the future time may lead to an increase of the garbage growth rate in the future. In order to obtain a more accurate target garbage gathering point, the management platform 230 may determine the population activity of the preset area at the further time based on a second preset rule according to the community population activity of the current time point. In some embodiments, the management platform 230 may collate the historical times of a plurality of preset areas and the historical population activity into a data comparison table, and determine the population activity of the preset area at the future time based on the data comparison table. For example, the corresponding historical population activity of the historical time of the community A at 08:00 and 10:15 on Jan. 1, 2024 based on the data comparison table is 1000 and 600 respectively. If the population activity at the current time point of 08:00 on Jan. 1, 2025 is 1200, it may be determined that the population activity of the preset area at the further time of 10:15 on Jan. 1, 2025 is 1200×600÷ 1000=720.

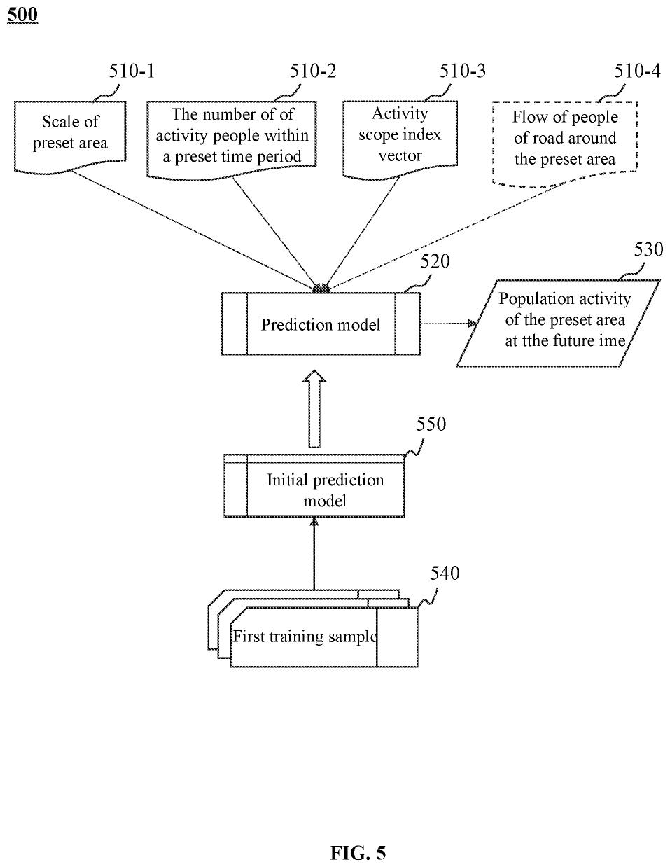

In some embodiments, the management platform 230 may predict the population activity of the preset area at the further time through a prediction model based on the scale of the preset area, and the number of activity people, and an activity scope index vector within a preset time period, and the prediction model is a machine learning model. For more details of determining the population activity of the preset area at the future time through the prediction model, please refer to FIG. 5 and its related descriptions.

In some embodiments, the management platform 230 may determine the population activity of the preset area based on the number of people entering and leaving the preset area and the population activity of the preset area at the future time.

In some embodiments, the management platform 230 may set a third preset rule for the number of people entering and leaving the preset area and the population activity of the preset area at the future time and the population activity of the preset area, and determine the population activity of the preset area based on the third preset rule. For example, the management platform 230 may set the third preset rule as that the population activity of the preset area is an average value of the number of people entering and leaving the preset area and the population activity of the preset area at the future time. Exemplarily, the number of people entering and leaving the community A from 08:00 to 12:00 on Jan. 1, 2025 is 600, it is predicted that the population activity at the future time of 17:00 on Jan. 1, 2025 is 1,000, and then the population activity of the community A is 800.

The population activity of the preset area is jointly determined through the number of people entering and leaving the preset area and the population activity of the preset area at the future time. Considering that the population activity of the preset area at the future time changes due to changes in time, the determined population activity of the preset area is more comprehensive and accurate.

In some embodiments, the management platform 230 may obtain the activity scope of each resident in the preset area, and determine the activity scope index of each resident based on the activity scope of each resident, and thus determine the population activity of the preset area based on the weighted calculation result of the activity scope index of each resident.

The activity scope refers to the spatial scope of daily activities carried out by the residents in the preset area. In some embodiments, the activity scope may include the number of residents appearing in the preset area pictures within the certain time period, and the number of monitoring devices in which the residents appear within the certain time period. For example, from 08:00 to 12:00 on Jan. 1, 2025, the number of a certain resident in the community A appearing on camera of an east gate is 3, the number of a certain resident in the community A appearing on camera of a north gate is 1, and the number of a certain resident in the community A appearing on camera of a west gate is 1, thus the activity scope from 08:00 to 12:00 on Jan. 1, 2025 may include that the number of the resident appearing in the picture of the community A is 5 and the number of monitoring devices in which the resident appears in is 3.

In some embodiments, the management platform 230 may obtain the activity scope of each resident within the preset area through the monitoring device 140.

The activity scope index refers to relevant parameters capable of reflecting the activity scope.

In some embodiments, the management platform 230 may determine the activity scope index of each resident according to the activity scope of each resident. For example, the management platform 230 may set the calculation formula of the activity scope index as: the activity scope index=k×the number of residents appearing in the pictures of the preset area within the certain time period×the number of monitoring devices in which residents appear, where k denotes a constant, which may be set automatically by the system or manually according to actual requirements. Exemplarily, the activity scope of a certain resident in the community A from 08:00 to 12:00 on Jan. 1, 2025 is that the number of monitoring devices at the east gate in which residents appear is 3, the number of monitoring devices at the north gate in which residents appear is 1, and the number of monitoring devices at the west gate in which residents appear is 1, and k is set as 1, then the activity scope index of the resident is 1×5×3=15.

In some embodiments, the management platform 230 may determine the population activity of the preset area based on the weighted calculation result of the activity scope index of each resident. The greater the activity scope index of the residents is, the greater the corresponding weight is when calculating the population activity of the preset area. For example, there are three residents a, b, and c in the community A, and the activity scope index is 15, 30, and 30 respectively, thus the population activity of the community A may be 15×20%+30×40%+30×40%=27.

By calculating the weighted calculation results of the activity scope index of each residence, the population activity of the preset area is determined. Considering that the larger activity scope of the residents indicates the greater activity of the residents, the determined population activity of the preset area is more comprehensive and accurate.

In some embodiments, the preset area may include a plurality of sub-areas, each of which has a different distance from at least one garbage gathering point. The weight corresponding to the activity scope index of each resident is related to a plurality of sub-areas. The distance between each sub-area and at least one garbage gathering point is the sum of the distances between each sub-area and each garbage gathering point. For example, there are three residents a, b, and c in the community A, and the activity scope index is 15, 30, and 30 respectively, the distance between the sub-area where the resident a frequently moves and at least one garbage gathering point is minimum, thus the weight of the resident a is large, and the population activity of the community A may be 15×40%+30×30%+30×30%=24.

Step 430, determining the growth rate of the at least one garbage gathering point based on the scale of the preset area and the population activity of the preset area.

In some embodiments, the management platform 230 may set the calculation formula of the garbage growth rate as: the garbage growth rate=k′×(the scale of the preset area+the population activity of the preset area), where k′ denotes a constant, which may be set automatically by the system or manually according to actual requirements. For example, if k′ is 0.05, the scale of the community A is 1500, the population activity is 500, and the corresponding garbage growth rate is 100 L/h.

The population activity is determined based on the entry and exit record of the entrances and exits of the preset area, so that the garbage growth rate of the at least one garbage gathering point is determined based on the scale of the preset area and the population activity of the preset area. Because of not only considering the scale of the preset area, but also the population activity of the preset area, the garbage growth rate of at least one garbage gathering point may be more accurately determined.

FIG. 5 is a schematic diagram of an exemplary process 500 for determining the population activity of the preset area at the future time according to some embodiments of this disclosure.

In some embodiments, the management platform 230 may predict the population activity of the preset area at the future time through the prediction model based on the scale of the preset area and number of activity people and the activity scope index vector within the preset time period.

In some embodiments, the prediction model may be used to predict the population activity of the preset area at the future time. The prediction model may be a machine learning model, such as a Deep Neural Networks (DNN) model, a Recurrent Neural Network (RNN) model, or the like, or any combination thereof.

In some embodiments, as shown in FIG. 5, the input of the prediction model 520 may include the scale of the preset area 510-1, the number of activity people 510-2 within the preset time period and the activity scope index vector 510-3. The output of the prediction model 520 may include the population activity 530 of the preset area at the future time.

The number of activity people 510-2 within the preset time period may refer to the number of activity people in the preset area within the preset time period. For example, the activity people in community A form 09:00 to 12:00 on Jan. 1, 2025 may be 100 different people taken by the monitoring camera at the east gate, the monitoring camera at the north gate, the camera at the west gate, and the camera at the south gate.

In some embodiments, the management platform 230 may determine the number of activity people within the preset time period through the image recognition model. In some embodiments, the input of the image recognition model may include a picture sequence captured by monitoring devices in the preset area within the preset time period, and the output of the image recognition model may include the number of activity people within the preset time period. For more contents such as the training of the image recognition model, please refer to the relevant descriptions of determining the flow of people of the road around the preset area through the image recognition model, which will not be repeated here.

The activity scope index vector 510-3 may refer to vectors composed of the activity scope index of each person taken by the monitoring device in the preset area. For example, the activity scope index vector of the community A from 09:00 to 10:00 on Jan. 1, 2025 may be the vector [4, 1, 15, 8, 4] composed of the activity scope index of 5 persons.

In some embodiments, the input of the prediction model 520 may also include the flow of people 510-4 of the road around the preset area. For more details on the flow of people of the road around the preset area, please refer to FIG. 4 and its related descriptions.

The population activity of the preset area at the future time is determined by adding the flow of people of the road around the preset area. It is considered that the larger flow of people of the road around the preset area makes the determined population activity of the preset area more comprehensive and accurate.

In some embodiments, the prediction model 520 may be trained through a plurality of tagged training samples. A plurality of first training samples 540 with tags may be inputted into an initial prediction model 550, and a loss function may be constructed through the tags and the results of the initial prediction model 550. The parameters of the initial prediction model 550 are iteratively updated based on the loss function. Model training is completed when the loss function of the initial prediction model 550 meets the preset conditions, and the trained prediction model 520 is obtained, and the preset conditions may be convergence of the loss function, the number of iterations reaching the threshold, etc.

In some embodiments, the first training samples 540 may include the scale of the sample preset area, the number of activity people and the sample activity scope index vector within the sample preset time period. The tags may be the population activity of the preset area of the samples at the future time. In some embodiments, the first training samples 540 may be obtained by big data analysis, for example, the first training samples may be obtained by performing statistical analysis and processing a large amount of data obtained from a third-party platform and the historical input information of a plurality of preset areas, and the tags may be obtained by manual labeling.

When the input of the prediction model 520 may also include the flow of people 510-4 of the road around the preset area, the first training samples 540 may also include the flow of people of the road around the sample preset area.

According to some embodiments of this disclosure, the scale of the preset area, the number of activity people within the preset time period, the activity scope index vector, and the flow of people of the road around the preset area are processed through the prediction model, the population activity of the preset area at the future time may be more conveniently and accurately determined.

FIG. 6 is a schematic diagram of an exemplary process 600 of determining the level of household garbage generation according to some embodiments of this disclosure.

In some embodiments, the management platform 230 may determine the level of household garbage generation based on the scale of the preset area and the water and electrical data of the residents of the preset area.

In some embodiments, an estimation model may be used to estimate the level of household garbage generation. The estimation model may be a machine learning model, such as a DNN model, an RNN model, or the like, or any combination thereof.

In some embodiments, as shown in FIG. 6, the input of the estimation model 620 may include the scale 610-1 of the preset area and the water and electrical data 610-2 of the residents in the preset area. The output of the estimation model 620 may include the level 630 of household garbage generation.

In some embodiments, the input of the estimation model 620 may also include the population activity 610-3 of the preset area. The greater the population activity of the preset area is, the shorter the time of the residents spending at home in the preset area may be, and the lower the level of household garbage generation may be, that is, the level of household garbage generation in the preset area is inversely proportional to the population activity of the preset area.

The level of household garbage generation is determined by adding the population activity of the preset area. Considering that the greater population activity makes the level of household garbage generation lower, the determined level of household garbage generation is more comprehensive and accurate.

In some embodiments, the estimation model 620 may be trained through a plurality of tagged training samples. A plurality of second training samples 640 with tags may be inputted into an initial estimation model 650. A loss function is constructed through the tags and the results of the initial estimation model 650, and the parameters of the initial estimation model 650 are iteratively updated based on the loss function. Model training is completed when the loss function of the initial estimation model 650 meets the preset conditions, and the trained estimation model 620 is obtained, and the preset conditions may be the convergence of the loss function, the number of iterations reaching the threshold, etc.

In some embodiments, the second training samples 640 may include the scale of the sample preset area and the water and electrical data of the residents of the sample preset area. The tags may be the level of sample household garbage generation. In some embodiments, the second training samples 640 may be obtained by big data analysis, for example, the second training samples may be obtained by performing statistic analysis and processing a large amount of data obtained from a third-party platform and the historical input information of a plurality of preset areas, and the tags may be obtained by manual labeling.

When the input of the estimation model 620 may also include the population activity 610-3 of the preset area, the first training samples 540 may also include the population activity of the sample preset area.

According to some embodiments of this disclosure, the scale of the preset area, the water and electrical data of the residents in the preset area, and the population activity of the preset area are processed through the estimation model, and a plurality of preset areas may be analyzed at the same time, so that the efficiency of computing is improved, the determination process of the level of household garbage generation is more efficient, and the accuracy of the determined level of household garbage generation is significantly improved.

It should be noted that different embodiments may produce different beneficial effects. In different embodiments, the beneficial effects that may be produced may be any one or combination of the above or any other beneficial effects that may be obtained.

Some embodiments of this description also disclose a computer readable storage medium. The storage medium stores computer instructions. When a computer reads the computer instructions in the storage medium, the computer executes the method for determining the garbage treatment in the smart city in any of the above embodiments.

Having described the basic concepts above, it is clear that the above detailed disclosures are intended only as examples for technicians skilled in the art and do not constitute the qualification of this description. Although it is not explicitly stated herein, this description may be subject to various modifications, improvements and corrections by technicians skilled in the art. Such modifications, improvements and corrections are suggested in this description and therefore remain within the spirit and scope of the demonstration embodiments of this description.

Furthermore, unless expressly stated in the claims, the order or elements and sequences of treatment, the use of alphanumeric numbers, or other names described in this description shall not be used to define the order of processes and methods in this description. Although the above disclosure discusses some embodiments of the disclosure currently considered useful by various examples, it should be understood that such details are for illustrative purposes only, and the additional claims are not limited to the disclosed embodiments. In stead, the claims are intended to cover all combinations of corrections and equivalents consistent with the substance and scope of the embodiments of the disclosure. For example, although the implementation of various components described above may be embodied in a hardware device, it may also be implemented as a software only solution, e.g., an installation on an existing server or mobile device.

Finally, it should be understood that the embodiments described in this description are intended only to illustrate the principles of the embodiments of this description. Other variants may also fall within the scope of this description. Therefore, as examples rather than restrictions, alternative configurations of the embodiments of this description may be considered to be consistent with the instruction of this description. Correspondingly, the embodiments of this description are not limited to the embodiments of the present disclosure specifically introduced and described in this description.

What is claimed is:

1. A method for determining garbage treatment in a smart city, implemented based on an Internet of Things system for determining the garbage treatment in the smart city, wherein the Internet of Things system for determining the garbage treatment in the smart city includes a management platform, a sensor network platform, and an object platform; and
the method is executed by the management platform, the method comprising:
obtaining an image of at least one garbage gathering point in a preset area and a scale of the preset area based on the object platform;
determining a current garbage amount of the at least one garbage gathering point based on the image of the at least one garbage gathering point;
determining a garbage growth rate of the at least one garbage gathering point based on the scale of the preset area;
determining a target garbage gathering point based on the current garbage amount of the at least one garbage gathering point and the garbage growth rate of the at least one garbage gathering point; and
controlling a garbage treatment device to treat garbage at the target garbage gathering point.

2. The method of claim 1, wherein the management platform includes a plurality of management sub-platforms, the plurality of management sub-platforms correspond to a plurality of management sub-platform databases in a one-to-one manner; and the plurality of management sub-platforms correspond to different city areas.

3. The method of claim 2, wherein the Internet of Things system for determining the garbage treatment in the smart city further includes a service platform and a user platform; the user platform is configured to receive a query request for treating the garbage initiated by a user, and transmit the query request to the management platform based on the service platform.

4. The method of claim 2, wherein the sensor network platform includes a sensor network general platform database, a plurality of sensor network sub-platforms, and a plurality of sensor network sub-platform databases, the plurality of sensor network sub-platforms correspond to the plurality of sensor network sub-platform databases in a one-to-one manner; and the plurality of sensor network sub-platforms correspond to different city areas.

5. The method of claim 1, wherein the determining a garbage growth rate of the at least one garbage gathering point based on the scale of the preset area includes:
determining a number of people entering and leaving the preset area based on an entry and exit record of entrances and exits in the preset area;
determining a population activity of the preset area based on the number of people entering and leaving the preset area; and
determining the garbage growth rate of the at least one garbage gathering point based on the scale of the preset area and the population activity of the preset area.

6. The method of claim 5, wherein the determining a population activity of the preset area based on the number of people entering and leaving the preset area includes:
determining a flow of people of road around the preset area; and
determining the population activity of the preset area based on the number of people entering and leaving the preset area and the flow of people of the road around the preset area.

7. The method of claim 5, wherein the determining the population activity of the preset area based on the number of people entering and leaving the preset area includes:
determining a population activity of the preset area at a future time; and
determining the population activity of the preset area based on the number of people entering and leaving the preset area and the population activity of the preset area at the future time.

8. The method of claim 5, wherein the determining the population activity of the preset area based on the number of people entering and leaving the preset area includes:
obtaining an activity scope of each resident in the preset area;
determining an activity scope index of each resident based on the activity scope of each resident; and
determining the population activity of the preset area based on a weighted calculation result of the activity scope index of each resident.

9. The method of claim 8, wherein the preset area includes a plurality of sub-areas, distances between each of the plurality of sub-areas and the at least one garbage gathering point are different, and a weight value corresponding to the activity scope index of each resident is related to the plurality of sub-areas.

10. The method of claim 1, wherein the determining a garbage growth rate of the at least one garbage gathering point based on the scale of the preset area includes:
determining a level of household garbage generation in the preset area based on water and electrical data of residents in the preset area; and
determining the garbage growth rate of the at least one garbage gathering point based on the level of household garbage generation in the preset area.

11. The method of claim 10, wherein the determining the level of household garbage generation in the preset area based on the water and electrical data of the residents in the preset area includes: determining the level of household garbage generation through a prediction model based on the scale of the preset area and the water and electrical data of the residents in the preset area.

12. An Internet of Things system for determining garbage treatment in a smart city, comprising a management platform, a sensor network platform, and an object platform, wherein:
the object platform is configured to obtain an image of at least one garbage gathering point in a preset area and a scale of the preset area and transmit the image of the at least one garbage gathering point to the management platform through the sensor network platform;
the management platform is configured to determine a current garbage amount of the at least one garbage gathering point based on the images of the at least one garbage gathering point;
the management platform is configured to determine a garbage growth rate of the at least one garbage gathering point based on the scale of the preset area; and
the management platform is configured to determine a target garbage gathering point based on the current garbage amount of the at least one garbage gathering point and the garbage growth rate of the at least one garbage gathering point.

13. The system of claim 12, wherein the management platform includes a plurality of management sub-platforms and a plurality of management sub-platform databases, the plurality of management sub-platforms correspond to the plurality of sub-platform databases in a one-to-one manner, and the plurality of management sub-platforms correspond to different city areas.

14. The system of claim 13, further comprising a service platform and a user platform, wherein the user platform is configured to receive a query request for treating garbage initiated by a user, and transmit the query request to the management platform based on the service platform.

15. The system of claim 13, wherein the sensor network platform includes a sensor network general platform database, a plurality of sensor network sub-platforms, and a plurality of sensor network sub-platform databases, the plurality of sensor network sub-platforms correspond to the plurality of sensor network sub-platform databases in a one-to-one manner, and the plurality of sensor network sub-platforms correspond to different city areas.

16. The system of claim 12, wherein the determining a garbage growth rate of the at least one garbage gathering point based on the scale of the preset area includes:
determining a number of people entering and leaving the preset area based on an entry and exit record of entrances and exits in the preset area;
determining a population activity of the preset area based on the number of people entering and leaving the preset area; and
determining the garbage growth rate of the at least one garbage gathering point based on the scale of the preset area and the population activity of the preset area.

17. The system of claim 16, wherein the determining the population activity of the preset area based on the number of people entering and leaving the preset area includes:
determining a flow of people on road around the preset area; and
determining the population activity of the preset area based on the number of people entering and leaving the preset area and the flow of people on the road around the preset area.

18. The system of claim 16, wherein the determining the population activity of the preset area based on the number of people entering and leaving the preset area includes:
determining a population activity of the preset area at a future time; and
determining the population activity of the preset area based on the number of people entering and leaving the preset area and the population activity of the preset area at the future time.

19. The system of claim 16, wherein the determining the population activity of the preset area based on the number of people entering and leaving the preset area includes:
obtaining an activity scope of each resident in the preset area;
determining an activity scope index of each resident based on the activity scope of each resident; and
determining the population activity of the preset area based on a weighted calculation result of the activity scope index of each resident.

20. A non-transitory computer readable storage medium, wherein the storage medium stores computer instructions, when the computer instructions are executed by a processor, the method of claim 1 is implemented.
